(19) United States
(12) Patent Application Publication
(10) Pub. No.: US 2025/0379963 A1
(43) Pub. Date: Dec. 11, 2025

(54) METHOD OF POSTURE DETERMINING FOR TRACKING DEVICE, HEADSET AND TRACKING DEVICE

(71) Applicant: Beijing Zitiao Network Technology Co., Ltd., Beijing (CN)

(72) Inventors: Qinglin CHEN, Beijing (CN); Qingjian JIAO, Beijing (CN); Junliang SHAN, Beijing (CN); Tao WU, Beijing (CN); Xiaohui LIU, Beijing (CN)

(21) Appl. No.: 19/230,412

(22) Filed: Jun. 6, 2025

(30) Foreign Application Priority Data
Jun. 6, 2024 (CN) 202410732765.8

(51) Int. Cl. H04N 13/366; G06F 3/01; H04N 13/327; H04N 13/344; H04N 13/398

(52) U.S. Cl. CPC H04N 13/366; G06F 3/014; H04N 13/327; H04N 13/344; H04N 13/398

(57) ABSTRACT

The present disclosure relates to a method of posture determining for a tracking device, a headset and a tracking device. The method of posture determining includes: receiving, by the headset, IMU data sent by the tracking device, performing integration processing on the IMU data, to obtain real-time posture data of the tracking device; receiving first posture data sent by the tracking device, where the first posture data is posture data of the tracking device at the current moment, obtained by the tracking device by performing integration processing according to the IMU data obtained through measurement, and after the IMU data is lost, the tracking device continuously performs integration processing according to the IMU data obtained through measurement; and determining real-time posture data of the tracking device at the current moment according to the first posture data.

### CROSS-REFERENCE TO RELATED APPLICATION

This application claims the priority to and benefits of the Chinese Patent Application No. 202410732765.8, which was filed on Jun. 6, 2024. The aforementioned patent application is hereby incorporated by reference in its entirety.

### TECHNICAL FIELD

Embodiments of this application relate to a method of posture determining for a tracking device, a headset and a tracking device.

### BACKGROUND

Extended reality (Extended Reality, XR) is to create, by combining reality with virtuality by using a computer, a virtual environment for human-computer interaction, to bring “immersion” of seamless transition between a virtual world and a real world for experiencers.

An XR device usually tracks pose information of human body movement by using a tracking device (also referred to as a tracker) worn on a hand and/or a foot of a user. The tracking device obtains inertial data (also referred to as IMU data) through measurement by using an inertial sensor (Inertial Measurement Unit, IMU), and sends the IMU data to a headset in a wireless communication manner, and the headset determines a pose of the tracking device according to the IMU data. However, wireless transmission is unstable, and is vulnerable to signal strength, transmission bandwidth, block, a long distance, and interference of other wireless communication. As a result, the headset does not receive the IMU data of the tracking device.

After the IMU data sent by the tracking device to the headset is lost, the pose of the tracking device determined by the headset has an offset.

### SUMMARY

An embodiment of the application provides a method of posture determining for a tracking device, a headset and a tracking device. The tracking device performs integration processing on the IMU data, and uploads the posture data obtained through the integration to the headset. The headset recovers the posture data obtained through integration by itself, according to the posture data uploaded by the tracking device, to obtain the correct posture data of the tracking device at the recovery moment.

An embodiment of the application provides a method of posture determining for a tracking device, the method is applicable to a headset, and the method includes: receiving IMU data sent by the tracking device, the IMU data is data obtained through measurement by an IMU of the tracking device; performing integration processing on the IMU data, to obtain real-time posture data of the tracking device; receiving first posture data sent by the tracking device, the first posture data is posture data of the tracking device at the current moment, obtained by the tracking device by performing integration processing according to the IMU data obtained through measurement, and after the IMU data sent by the tracking device is lost, the tracking device continuously performs integration processing according to the IMU data obtained through measurement; and determining real-time posture data of the tracking device at the current moment according to the first posture data.

In some exemplary embodiments, the first posture data is posture transformation information of the tracking device, obtained by the tracking device by performing integration processing on lost IMU data from a loss moment of the IMU data to the current moment; and the determining the real-time posture data of the tracking device at the current moment according to the first posture data includes: superposing the first posture data based on second posture data to obtain the posture data of the tracking device at the current moment, the second posture data is real-time posture data of the tracking device at a first moment obtained by the headset through integration, and the first moment is a moment previous to the loss moment.

In some exemplary embodiments, the first posture data is real-time posture data of the tracking device, obtained by the tracking device by performing integration processing on all IMU data from an initial moment to the current moment; and the determining the real-time posture data of the tracking device at the current moment according to the first posture data includes: obtaining a posture difference between the headset and the tracking device, the posture difference indicates a difference between postures respectively obtained by the headset and the tracking device based on IMU data through integration; and performing posture adjustment on the first posture data according to the posture difference, to obtain the real-time posture data of the tracking device at the current moment.

In some exemplary embodiments, the first posture data is periodically sent by the tracking device according to a preset period, and before the determining the real-time posture data of the tracking device at the current moment according to the first posture data, the method further includes: determining, by the headset, whether the IMU data is lost and whether normal transmission is recovered at the current moment; in response to that it is determined that the IMU data is not lost, updating the posture difference according to the first posture data and the real-time posture data, the real-time posture data is obtained by the headset at the current moment by performing integration processing based on the IMU data; and in response to that it is determined that the IMU data is lost, and normal transmission is recovered at the current moment, determining to determine the real-time posture data of the tracking device at the current moment by using the first posture data.

In some exemplary embodiments, the method further includes: collecting light spot images of a plurality of light emitting units on the tracking device; and repositioning the tracking device by using a pose estimation algorithm according to the light spot images; and the performing integration processing on the IMU data, to obtain the real-time posture data of the tracking device includes: performing integration processing on the IMU data by using a repositioned posture as an initial posture, to obtain the real-time posture data of the tracking device.

In some exemplary embodiments, the headset performs integration processing by using a first integration algorithm, the tracking device performs integration processing by using a second integration algorithm, and the first integration algorithm is different from the second integration algorithm.

In some exemplary embodiments, the method further includes: sending a connection message to the tracking device according to a first frequency, where in response to that the IMU data is not lost, the connection message carries indication information indicating that the IMU data is not lost, and the tracking device sends the IMU data through a response message for the connection message; and in response to that the response message for the connection message sent by the tracking device is not received within a fixed period after sending the connection message, determining that the IMU data is lost, and after determining that the IMU data is lost, the connection message carries the indication information indicating that the IMU data is lost.

An embodiment of the application provides a method of posture determining for a tracking device, the method is applicable to the tracking device, and the method includes: obtaining IMU data through measurement by an IMU, and sending the IMU data to a headset; performing integration processing on the IMU data to obtain posture data of the tracking device, after the IMU data sent to the headset is lost, the tracking device continuously performs integration processing according to the IMU data obtained through measurement; and determining to send, at a current moment, first posture data that is obtained by the tracking device through integration, and sending the first posture data to the headset.

In some exemplary embodiments, the first posture data is posture transformation information of the tracking device, obtained by the tracking device by performing integration processing on lost IMU data from a loss moment of the IMU data to the current moment.

In some exemplary embodiments, the performing integration processing on the IMU data to obtain the posture data of the tracking device includes: receiving a connection message sent by the headset according to a first frequency; in response to that the connection message is received within a fixed period and the connection message indicates that the IMU data is not lost during sending, resetting the posture data of the tracking device, and continuing to perform integration processing according to the IMU data obtained through measurement, the tracking device sends the IMU data through a response message for the connection message; and in response to that the connection message is not received within the fixed period, determining that the IMU data is lost, skipping resetting the posture data of the tracking device, and continuing to perform integration processing according to the IMU data obtained through measurement.

In some exemplary embodiments, the determining to send, at the current moment, the first posture data that is obtained by the tracking device through integration includes: in response to that the connection message is received for the first time after the IMU data is lost and the connection message indicates that the IMU data is lost, determining to send, at the current moment, the first posture data that is obtained by the tracking device through integration, skipping resetting the posture data of the tracking device, and sending the response message for the connection message to the headset, the response message for the connection message includes IMU data at the current moment and the first posture data.

In some exemplary embodiments, the first posture data is real-time posture data of the tracking device, obtained by the tracking device by performing integration processing on all IMU data from an initial moment to the current moment. The performing integration processing on the IMU data to obtain the posture data of the tracking device includes: performing, from the initial moment, integration on all the IMU data obtained through measurement, to obtain the real-time posture data of the tracking device.

When the first posture data is real-time posture data of the tracking device, obtained by the tracking device by performing integration processing on all IMU data from an initial moment to the current moment, in some exemplary embodiments, the determining to send, at the current moment, the first posture data that is obtained by the tracking device through integration includes: determining, according to a preset period, to send the first posture data at the current moment.

When the first posture data is real-time posture data of the tracking device, obtained by the tracking device by performing integration processing on all IMU data from an initial moment to the current moment, in some exemplary embodiments, the determining to send, at the current moment, the first posture data that is obtained by the tracking device through integration includes: upon receiving a request message sent by the headset, determining to send the first posture data at the current moment, where the request message is sent in response to that the headset determines that the IMU data is lost and normal transmission is recovered, and the request message is used to request the tracking device to send the real-time posture data of the tracking device.

In some exemplary embodiments, the sending the first posture data to the headset includes: receiving a connection message sent by the headset according to a first frequency; and sending a response message for the connection message to the headset, the response message for the connection message includes the first posture data and IMU data at the current moment.

An embodiments of the application provide an apparatus of posture determining for a tracking device, the apparatus is applicable to a headset, and the apparatus includes: a receiving module, configured to receive IMU data sent by the tracking device, the IMU data is data obtained through measurement by an IMU of the tracking device; an integration module, configured to perform integration processing on the IMU data, to obtain real-time posture data of the tracking device; the receiving module is further configured to receive first posture data sent by the tracking device, the first posture data is posture data of the tracking device at the current moment, obtained by the tracking device by performing integration processing according to the IMU data obtained through measurement, and after the IMU data sent by the tracking device is lost, the tracking device continuously performs integration processing according to the IMU data obtained through measurement; and a posture determining module, configured to determine real-time posture data of the tracking device at the current moment according to the first posture data.

An embodiment of the application provides an apparatus of posture determining for a tracking device, the apparatus is applicable to the tracking device, and the apparatus includes: a measurement unit, configured to obtain IMU data through measurement by using an IMU, and send the IMU data to a headset; an integration module, configured to perform integration processing on the IMU data to obtain posture data of the tracking device, where after the IMU data sent to the headset is lost, the tracking device continuously performs integration processing according to the IMU data obtained through measurement; a sending module, configured to determine to send, at a current moment, first posture data obtained by the tracking device through integration, and send the first posture data to the headset.

An embodiment of the application provides a headset, and the headset includes a processor and a memory. The memory is configured to store a computer program, and the processor is configured to invoke and run the computer program stored in the memory, to perform the method as described above.

An embodiment of the application provides a tracking device, and the tracking device includes processor and a memory. The memory is configured to store a computer program, and the processor is configured to call and run the computer program stored in the memory, to perform the method as described above.

An embodiment of the application provides a computer-readable storage medium for storing a computer program. The computer program causes a computer to perform the method as described above.

An embodiment of the application provides a computer program product, including a computer program, which, when executed by a processor, realizes the method as described above.

An embodiment of the application provides a VR system, which includes a headset and at least one tracking device, where the headset and the tracking device communicate through wireless communication, and the headset is used for performing the related method described above, and the tracking device is used for performing the related method described above.

### BRIEF DESCRIPTION OF DRAWINGS

In order to explain the technical solution in the embodiment of the present disclosure more clearly, the accompanying drawings needed in the description of the embodiment will be briefly introduced below. Obviously, the drawings in the following description are only some embodiments of the present disclosure. For those skilled in the art, other drawings may be obtained according to these drawings without creative work.

FIG. 1 is a schematic diagram of an application scenario according to embodiments of this application;

FIG. 2 is a schematic diagram of wearing a tracking device;

FIG. 3 is a flowchart of a method of posture determining for a tracking device according to at least one embodiment of this application;

FIG. 4 is a flowchart of a method of posture determining for a tracking device according to at least one embodiment of this application;

FIG. 5 is a sequence diagram of data transmission between a headset and a tracking device in a first compensation manner;

FIG. 6 is a sequence diagram of data transmission between a headset and a tracking device in a second compensation manner;

FIG. 7 is an apparatus of posture determining for a tracking device according to at least one embodiment of this application;

FIG. 8 is an apparatus of posture determining for a tracking device according to at least one embodiment of this application; and

FIG. 9 is a schematic structural diagram of a headset according to at least one embodiment of this application.

### DETAILED DESCRIPTION

Embodiments of this application provide a method of posture determining for a tracking device, and the method is applicable to extended reality (Extended Reality, XR). XR means all reality and virtuality combined environments and human-computer interaction that are generated by a wearable device with computer technologies. XR includes a plurality of forms such as virtual reality (Virtual Reality, VR), augmented reality (Augmented Reality, AR), and mixed reality (Mixed Reality, MR). For ease of understanding of embodiments of this application, before the embodiments of this application are described, some concepts in an XR scene involved in all embodiments of this application are first properly explained and described, and details are as follows:

(1) VR is a technology for creating and experiencing a virtual world, determines to generate a virtual environment, and is multi-source information (virtual reality mentioned in this specification includes at least visual perception, also includes auditory perception, haptic perception, motion perception, and even gustatory perception, olfactory perception, and the like), to implement a fused, interactive three-dimensional dynamic view of the virtual environment and simulation of entity behaviors, so that users are immersed in the simulated virtual reality environment, to implement applications in a plurality of virtual environments such as maps, games, videos, education, medical, simulation, collaborative training, sales, assistance in manufacturing, and maintenance and repair.

(2) A virtual reality device (VR device) is a terminal that implements a virtual reality effect, and may be usually provided as a form of glasses, a head mount display (Head Mount Display, HMD for short), and contact lenses, to implement visual perception and perception in another form. Certainly, forms implemented by the virtual reality device are not limited thereto, and may be further miniaturized or enlarged according to actual requirements.

Optionally, virtual reality devices disclosed in embodiments of this application may include but are not limited to the following types:

(2.1) A computer terminal virtual reality (PCVR) device uses a PC terminal to perform calculations related to virtual reality functions and data output, and the external computer terminal virtual reality device uses data output by the PC terminal to achieve virtual reality effects.

(2.2) A mobile virtual reality device supports disposing a mobile terminal (for example, a smartphone) in various manners (for example, a head mount display equipped with a dedicated card slot), and by connecting to the mobile terminal in a wired or wireless manner, the mobile terminal performs calculations related to a virtual reality function and outputs data to the mobile virtual reality device, for example, to watch a virtual reality video through an APP of the mobile terminal.

(2.3) An all-in-one virtual reality device has a processor for performing calculations related to virtual functions, and therefore has independent virtual reality input and output functions, and does not need to be connected to a PC terminal or a mobile terminal, providing a high degree of freedom of use.

(3) A virtual field is an area that is in a virtual environment and that may be perceived by a user through a lens in a virtual reality device, and the perceived area is represented by using a field of view (Field Of View, FOV) of the virtual field.

(4) AR is a technology that calculates, in real time, camera posture parameters of a camera in a real world (or referred to as a three-dimensional world or a real world) in an image acquisition process of the camera, and adds, based on the camera posture parameters, virtual elements to images acquired by the camera. The virtual elements include but are not limited to: images, videos, and three-dimensional models. An objective of the AR technology is to socket the virtual world onto the real world on the screen for interaction.

(5) MR is a simulated setting that integrates a computer-created sensory input (for example, a virtual objects) with a sensory input from a physical setting or a representation thereof. In some MR settings, the computer-created sensory input is adaptive to a change in the sensory input from the physical setting. In addition, some electronic systems used to present the MR settings may monitor an orientation and/or a position relative to the physical setting, to enable the virtual object to interact with a real object (that is, a physical element from the physical setting or a representation thereof). For example, the system may monitor movement, so that a virtual plant appears to be stationary relative to a physical building.

(6) A virtual scene is a virtual scene that is displayed (or provided) by an application when the application is run on an electronic device. The virtual scene may be a simulated environment of the real world, a semi-simulated and semi-fictional virtual scene, or a purely fictional virtual scene. The virtual scene may be any one selected from the group consisting of a two-dimensional virtual scene, a 2.5-dimensional virtual scene, and a three-dimensional virtual scene, and dimensions of the virtual scene are not limited in embodiments of this application. For example, the virtual scene may include a sky, a land, an ocean, and the like, and the land may include environmental elements such as a desert, a city, and the like. The user may control the virtual object to move in the virtual scene.

(7) A virtual object is an object for interaction in a virtual scene, an object that is controlled by a user or a robot program (for example, an artificial intelligence-based robot program) and that is capable of being stationary, moving, and performing various behaviors in a virtual scene, such as various roles in games.

To clearly describe technical solutions in this application, an application scenario of technical solutions of this application are described below. It should be understood that, the technical solutions of this application may be applicable to the following scenario, but this application is not limited thereto:

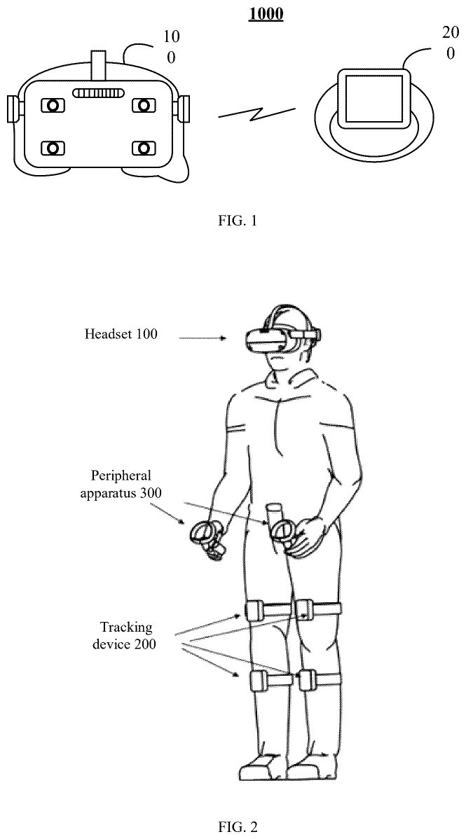

For example, FIG. 1 is a schematic diagram of an application scenario according to an embodiment of this application. As shown in FIG. 1A, the application scenario 1000 may include a headset 100 and a tracking device 200. In addition, the headset 100 may communicate with the tracking device 200. The headset 100 is also referred to as a head-mounted display device. The tracking device 200 is also referred to as a motion capturing device or a tracker.

In some implementations, the headset 100 may be an HMD, for example, a head-mounted display in a VR all-in-one machine, which is not limited in this embodiment.

In addition, a camera is disposed on the headset 100, to collect surrounding environment data by using the camera, and perform tracking positioning by using a simultaneous localization and mapping (simultaneous localization and mapping, SLAM for short) algorithm in computer vision based on the collected surrounding environment data. The number of the cameras may be at least one, and an example in which there are four cameras is used in FIG. 1 for description. In addition, a type of the camera may be a fish-eye camera, a common camera, or another type of camera. This is not limited in this application.

In embodiments of this application, the tracking device 200 includes an inertial measurement unit (Inertial Measurement Unit, IMU for short). The IMU may be a six-axis IMU, or a nine-axis IMU. This is not specifically limited herein. The IMU is configured to measure inertial data of the tracking device 200. The inertial data obtained through measurement by the IMU is referred to as IMU data below.

In some implementations, the tracking device 200 may be an optical tracker. The optical tracker has several light emitting units for positioning. These light emitting units are distributed at different positions of the optical tracker. When tracking a pose of movement of a human body, light spot images of the light emitting units are collected by the camera of the headset 100, and a pose of the optical tracker is determined according to a quantity N and coordinates of the light spot.

The tracking device 200 may be worn on different parts of the human body, for example, four limbs, a trunk, shoulders, and a waist and other parts of the human body. The four limbs of the human body include upper limbs and lower limbs. For example, as shown in FIG. 2, the tracking device 200 is worn on the lower limbs of the human body. The lower limbs of the human body include thighs and shanks. In other words, four tracking devices 200 may be respectively worn on thighs and shanks (or ankles) of the human body, to collect thigh movement data and shank movement data (collectively referred to as lower limb movement data) of the human body by using the tracking devices 200, and the lower limb movement data is sent to the headset 100, to track movement of the lower limbs of the human body.

It should be noted that, limb data collected by the tracking devices 200 worn on the four limbs of the human body may be three degrees of freedom (Dof) data or 6 Dof data.

Optionally, not only the tracking device 200 may be worn on the upper limbs of the human body, but also a peripheral apparatus 300 may be worn on the upper limbs of the human body, for example, worn on hands and/or arms of the human body. Then, the peripheral apparatus 300 collects upper limb movement data of the human body, and sends the upper limb movement data to the headset 100, to track upper limb movement of the human body. For details of a manner of wearing the peripheral apparatus 300, refer to FIG. 2.

In some implementations, the peripheral apparatus 300 may be but is not limited to: a handle, a glove, a wrist band, a wrist strap, a finger ring, and another wearable device. In addition, an inertial sensor is disposed on the peripheral apparatus 300, and the inertial sensor may provide 6 degrees of freedom data including upper limb positions and upper limb postures of the human body.

It may be understood that, in embodiments of this application, the tracking devices 200 are worn on the four limbs of the human body, or the peripheral apparatus 300 is worn on the upper limbs of the human body and the tracking device is worn on the lower limbs of the human body, so that whole-body tracking of the human body may be implemented.

It should be understood that, the headset 100, the tracking device 200, and the peripheral apparatus 300 shown in FIG. 1 and FIG. 2 are merely examples, and are not used as a specific limitation on this application.

After the application scenario of embodiments of this application are described, the following describes, in detail with reference to the accompanying drawings, a method and an apparatus of posture determining for a tracking device, a device, and a medium provided in embodiments of this application.

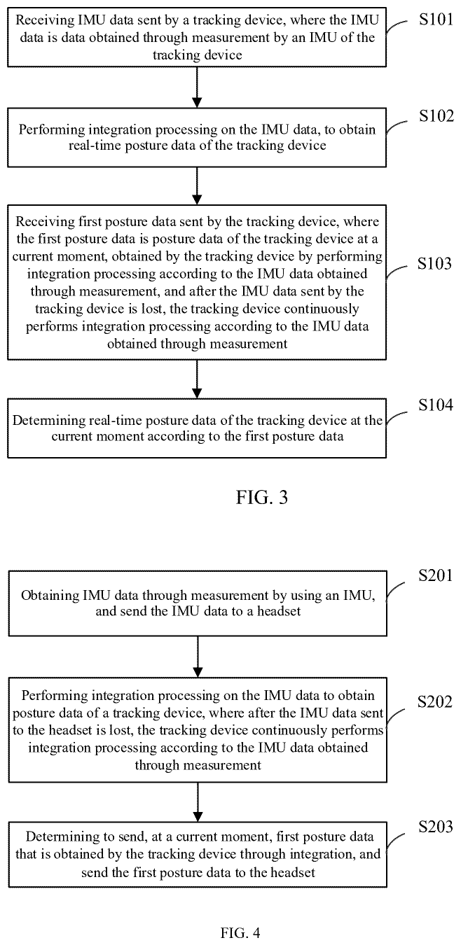

FIG. 3 is a flowchart of a method of posture determining for a tracking device according to at least one embodiment of this application. As shown in FIG. 3, the method in this embodiment includes the following steps.

At S101, receive IMU data sent by the tracking device, where the IMU data is data obtained through measurement by an IMU of the tracking device.

The IMU is disposed on the tracking device. The IMU collects the IMU data according to a first frequency, and sends the IMU data to the headset with the first frequency. For example, if the first frequency is 200 Hz, the tracking device obtains 200 frames of IMU data through measurement in one second, and sends all the 200 frames of IMU data to the headset through transmission for 200 times. Optionally, a frequency at which the tracking device collects the IMU data may be different from a frequency at which the tracking device sends the IMU data, and the frequency for collecting the IMU data is greater than the frequency for sending the IMU data.

The IMU data includes three-axis angular velocities, namely, an X-axis angular velocity, a Y-axis angular velocity, and a Z-axis angular velocity. The angular velocities indicate rotation speeds of the tracking device on the three axes, which are respectively denoted as ωₓ, ω_{y}, and ω_{z}.

The headset may be connected to one or more tracking devices. The headset communicates with each tracking device in a wireless communication manner. The wireless communication manner includes but is not limited to short-distance wireless communication such as Bluetooth (Bluetooth) communication, wireless fidelity (Wireless Fidelity, WIFI) communication and so on.

In a wireless communication manner, the headset and the tracking device use a manner of communication according to time slices. The headset sends a connection message to the tracking device at a fixed period interval or a fixed sending frequency. The tracking device opens, according to time slices, a receiver to receive the connection message, and after receiving the connection message sent by the headset, replies a response message for the connection message to the headset. The tracking device sends the response message for the connection message with the IMU data being carried in the response message, to the headset.

A sending frequency at which the headset device sends the connection message is the same as a sending frequency at which the headset sends the IMU data, both are the first frequency. The headset determines a time interval for sending the connection message according to the first frequency, and sends the connection message to the tracking device according to the sending time interval.

Optionally, the connection message is used to indicate whether the IMU data is lost, and may carry one-bit indication information in the connection message. The indication information is used to indicate whether IMU data of a previous frame or a previous moment is lost. For example, when a value of the bit corresponding to the indication information is 1, it indicates that no data loss occurred at the previous moment; and when the value of the bit corresponding to the indication information is 0, it indicates that data loss occurred at the previous moment.

In this communication manner, the IMU data loss includes the following two cases, and in the two cases, both the tracking device and the headset may determine that the IMU data is lost.

In the first case, loss of uplink data triggers loss of the IMU data, i.e., the IMU data sent by the tracking device to the headset is lost. In this case, after sending the connection message, if the headset does not receive the response message for the connection message after preset duration, it is considered that the IMU data is lost. After the headset determined that the IMU data is lost, a connection message to be sent at a next moment carries an indication message to indicate that the data loss occurred at the headset. The tracking device determines, according to the connection message to be sent at the next moment, that the IMU data is lost.

In the second case, loss of downlink data triggers loss of the IMU data. After the headset sends the connection message to the tracking device, the connection message may be lost. If the tracking device does not receive a connection message within a preset time after sending the response message for a connection message at a previous moment, it is considered that the connection message is lost. In this case, the tracking device does not send the response message for a connection message at the next moment. Therefore, the headset does not receive the IMU data subsequently, and the headset may also determine that the IMU data is lost.

In an actual situation, IMU data at one or a plurality of consecutive moments may be lost. In this communication manner, regardless of whether the IMU data is lost, the headset always sends the connection message at the sending frequency.

In another wireless communication manner, the tracking device actively sends the IMU data to the headset at the first frequency, and does not need to send the IMU data only after receiving the connection message sent by the headset.

At S102, perform integration processing on the IMU data, to obtain real-time posture data of the tracking device.

In this embodiment, both the headset and the tracking device perform 3Dof integration processing on the IMU data of the tracking device, to obtain the real-time posture data of the tracking device.

Optionally, an integration algorithm used by the headset is different from an integration algorithm used by the tracking device. Because the headset has a higher computing capability, the headset may use some relative complex integration algorithms, so that the posture data obtained by the headset through integration is more accurate.

In this embodiment, the real-time posture data obtained by the headset through integration according to the received IMU data may be represented by a quaternion. The IMU data represents rotation information of the tracking device, and the posture data obtained by directly performing integration on the IMU data is an accumulated rotation angle of the tracking device within a period of time. An initial posture of the tracking device needs to be provided, and integration is performed based on the IMU data on the basis of the initial posture to obtain the real-time posture of the tracking device.

For example, the headset determines, in a repositioning manner, the initial posture for integration processing, and the repositioning manner may be as follows: the headset collects light spot images of a plurality of light emitting units on the tracking device; and repositions the tracking device by using a pose estimation algorithm according to the light spot images, and performs integration processing on the IMU data by using a repositioned posture as an initial posture, to obtain the real-time posture data.

A light emitting unit is disposed on the tracking device, and the light emitting unit includes but is not limited to a light-emitting diode (LED) light, and a plurality of light emitting units are distributed inside a housing of the tracking device according to a preset rule. A camera on the headset shoots the light emitting units on the tracking device to obtain the light spot images, and repositions the tracking device by using a pose estimation algorithm, to obtain a current posture of the tracking device.

The pose estimation algorithm may be a perspective-n-point (Perspective-n-Point, PnP) algorithm. A value of n is greater than or equal to 3. For example, the value of n is 3 or 5. Correspondingly, the PnP algorithm is a P3P algorithm or a P5P algorithm.

The initial posture of the tracking device may be continuously corrected by using the repositioning method, and accuracy of the posture of the tracking device that is obtained by the headset through integration is improved by correcting the initial posture.

It may be understood that, when the headset and the tracking device perform normal communication, the headset may obtain the real-time posture of the tracking device through integration based on the manner.

At S103, receive first posture data sent by the tracking device, where the first posture data is posture data of the tracking device at the current moment, and obtained by the tracking device by performing integration processing according to the IMU data obtained through measurement, and after the IMU data sent by the tracking device is lost, the tracking device continuously performs integration processing according to the IMU data obtained through measurement.

In this embodiment, the first posture data may be posture transformation information of the tracking device, obtained by the tracking device by performing integration processing on lost IMU data from a loss moment of the IMU data to the current moment, or may be real-time posture data of the tracking device, obtained by the tracking device by performing integration processing on all IMU data from the initial moment to the current moment.

The loss moment is a moment at which the IMU data is lost, or is described as a moment at which a communication connection between the headset and the tracking device is disconnected. When the first posture data is the posture transformation information of the tracking device, obtained by the tracking device by performing integration processing on the lost IMU data from the loss moment of the IMU data to the current moment, the headset and the tracking device need to determine the loss moment and a recovery moment of the IMU data, and the tracking device sends the first posture data to the headset at the recovery moment.

The recovery moment is after the loss moment, and is not a determined moment. The recovery moment is a moment at which normal transmission of the IMU data is recovered. The moment at which normal transmission of the IMU data is recovered may also be described as a moment at which normal communication between the headset and the tracking device is recovered.

A disconnection time between the loss moment and the recovery moment may be quite short, for example, less than one second. The disconnection time may also be quite long, for example, may be 5 minutes, 10 minutes, or a longer time.

In this embodiment, after the IMU data is lost, because the tracking device may continuously perform integration processing, the first posture data obtained by the tracking device through integration includes the posture data from the loss moment to the recovery moment, so that the headset may perform posture compensation based on the first posture data. Optionally, the tracking device may send one message, carrying the first posture data and the IMU data at the current moment, to the headset, for example, send a response message for the same connection message, the response message carrying both of the first posture data and the IMU data at the current moment, to the headset.

Optionally, the headset determines, in the following manner, that the IMU data of the tracking device is lost and that normal transmission is recovered: The headset sends the connection message to the tracking device at the first frequency; and if the response message that is for the connection message and that is sent by the tracking device is not received within a fixed period after the connection message is sent, it is determined that the IMU data is lost. In this manner, after receiving the connection message each time, the tracking device sends the response message that is for the connection message and that carries the IMU data at the current moment, and to the headset.

The fixed period is related to the first frequency. When the first frequency is 200 Hz, that is, the connection message is sent for 200 times per second, an interval for sending the connection message is 1/200 second=0.005 seconds=5 milliseconds. In this case, the fixed period is 5 milliseconds. After the headset sends the connection message at a certain moment, if the response message for the connection message is not received within 5 milliseconds, it is determined that the IMU data is lost.

After determining that the IMU data is lost, the headset still continuously sends the connection message to the tracking device at the first frequency. The sent connection message carries indication information indicating that the IMU data is lost, to notify the tracking device that data is lost. When the IMU data is normally transmitted, the connection message carries indication information indicating that the IMU data is not lost.

After the IMU data is lost, when receiving the response message that is for the connection message and that is sent by the tracking device for the first time, the headset determines that normal transmission of the IMU data is recovered, where the response message for the connection message carries the IMU data at the current moment and the first posture data. It may be understood that, after the IMU data is lost, although the headset continuously sends connection messages, the tracking device does not send the response message for the connection message because it fails to receive the connection message, and only when normal communication between the headset and the tracking device is recovered, the tracking device may receive the connection message, and return the response message for the connection message, and send the response message for the connection message carrying the first posture data and the IMU data to the headset.

When the first posture data is the real-time posture data obtained by the tracking device through integration, the first posture data may be periodically sent by the tracking device according to a preset period or a second frequency. Optionally, the first frequency at which the tracking device sends the IMU data is greater than the second frequency at which the tracking device sends the first posture data. For example, if the first frequency is 200 Hz, and the second frequency is 1 Hz, the tracking device sends the IMU data for 200 times per second, and sends the first posture data once per second. Optionally, the first posture data may alternatively be sent by the tracking device based on a request of the headset. When determining that the IMU data is lost and that normal transmission is recovered, the headset may send a request message to the tracking device, to request the tracking device to send the real-time posture data obtained by itself through integration.

At S104, determine real-time posture data of the tracking device at the current moment according to the first posture data.

In this embodiment, the headset provides two posture compensation manners, for determining the real-time posture data of the tracking device at the recovery current.

In a first compensation manner, the first posture data is the posture transformation information of the tracking device, obtained by the tracking device by performing integration processing on the lost IMU data from the loss moment to the current moment.

In this implementation, the tracking device performs integration on all the lost IMU data from the loss moment by using an initial posture 0, to obtain the first posture data. Therefore, the first posture data represents the posture transformation information of the tracking device from the loss moment to the current moment.

Correspondingly, determining the real-time posture data of the tracking device at the current moment according to the first posture data includes: superposing the first posture data based on second posture data to obtain the posture data of the tracking device at the current moment. The second posture data is real-time posture data of the tracking device at a first moment, obtained by the headset through integration, and the first moment is a moment previous to the loss moment. The first posture data is the posture transformation information of the tracking device within a loss time. The headset obtains the posture data of the tracking device at the current moment, according to posture data of the tracking device before the loss and the posture transformation information accumulated within the loss time.

For example, the headset determines the real-time posture data of the tracking device at the current moment by using the following formula:

$${Q}_{current} = {Q}_{α} * {Q}_{Δ}$$

Q_{current} is the real-time posture data of the tracking device at the current moment determined by the headset, Q_{α} is the second posture data, that is, the real-time posture data obtained by the headset through integration, and Q_{Δ} is the first posture data.

In a second compensation manner, the first posture data is the real-time posture data of the tracking device, obtained by the tracking device by performing integration processing on all the IMU data from the initial moment to the current moment.

In this implementation, from the initial moment, the tracking device performs integration on all the IMU data from the initial moment to the current moment, to obtain the first posture data. Therefore, the first posture data represents the real-time posture of the tracking device.

In an implementation, determining, by the headset, the real-time posture data of the tracking device at the current moment according to the first posture data includes: obtaining a posture difference between the headset and the tracking device, and performing posture adjustment on the first posture data according to the posture difference, to obtain the real-time posture data of the tracking device at the current moment.

For example, the posture data of the tracking device at the current moment is determined by using the following formula:

$${Q}_{current} = {Q}_{β} * dQ$$

Q_{current} is the posture data of the tracking device at the current moment determined by the headset, Q_{β} is the first posture data (that is, the real-time posture data of the tracking device obtained through integration), and dQ represents the posture difference between the headset and the tracking device.

The posture difference indicates a difference between postures respectively obtained by the headset and the tracking device through integration based on IMU data, the posture difference may be a fixed value, or may be a dynamically changed value.

For example, the headset updates the posture difference according to a preset period. The preset period may be 0.5 seconds, 1 second, 2 seconds, 10 seconds, or a longer time. The preset period is the same as the preset period in which the tracking device uploads the first posture data. Correspondingly, before determining the real-time posture data of the tracking device at the current moment according to the first posture data, the headset determines whether the IMU data is lost and whether normal transmission is recovered at the current moment. When it is determined that the IMU data is not lost, the posture difference is updated according to the first posture data and the real-time posture data that is obtained by the headset at the current moment by performing integration processing based on the IMU data. When it is determined that the IMU data is lost and normal transmission is recovered at the current moment, it is determined to determine the real-time posture data of the tracking device at the current moment by using the first posture data.

It may be understood that, because the tracking device periodically uploads the real-time posture data obtained by itself through integration, after the IMU data is lost, when the headset receives, again, the real-time posture data uploaded by the tracking device, it may not be the recovery time of the IMU data, but the first time of receiving the real-time posture data uploaded by the tracking device after the normal transmission of the IMU data is recovered. Therefore, the headset performs posture compensation according to the posture difference and the received real-time posture data when receiving, for the first time, the real-time posture data uploaded by the tracking device after the IMU data is lost.

Assuming that the real-time posture data obtained by the tracking device through integration is Q_{α}, and the real-time posture data obtained by the headset through integration is Q_{β}, the posture difference dQ may be represented as:

$$dQ = inv ( {Q}_{α} ) * {Q}_{β}$$

Where inv represents an inverse operation.

In another implementation, determining, by the headset, the real-time posture data of the tracking device at the current moment according to the first posture data includes: determining the first posture data as the real-time posture data of the tracking device at the current moment. That is, the headset uses the real-time posture data obtained by the tracking device through integration as the real-time posture data of the tracking device at the current moment, and continues to perform integration processing.

Assuming that 100 packets of IMU data are lost from a particular moment, in this case, the headset does not receive the lost 100 packets of IMU data. As a result, the 100 packets of IMU data are not calculated by the headset. In this way, the posture data of the tracking device determined by the headset has a posture offset.

In the first compensation manner, the IMU data on the side of the tracking device is not lost, and the tracking device performs integration on the lost 100 packets of IMU data, to obtain the first posture data. When normal transmission of the IMU data is recovered, the first posture data is sent to the headset. The headset superposes the first posture data on the basis of the posture data obtained by the headset through integration, to obtain the real-time posture data of the tracking device at the current moment.

In the second compensation manner, during normal communication, both the headset and the tracking device perform integration processing based on the IMU data, to obtain the real-time posture data of the tracking device. The tracking device periodically sends the real-time posture data Q_{β} obtained by itself through integration to the headset, and the headset continuously updates the posture difference dQ based on the real-time posture data Q_{α} obtained by itself through integration and the real-time posture data Q_{β} obtained by the tracking device through integration. After the 100 packets of IMU data are lost, Q_{α} has a posture offset because the 100 packets of IMU data are not calculated, but Q_{β} is normal, and correct Q_{α} may be obtained according to dQ and Q_{β}.

According to the two compensation manners provided in this embodiment, when the headset is reconnected to the tracking device after being disconnected from the tracking device for a long time (for example, a disconnection time exceeds 30 minutes), the headset may still obtain the correct posture of the tracking device.

In this embodiment, the headset receives the IMU data sent by the tracking device, and performs integration processing on the IMU data to obtain the real-time posture data of the tracking device; receives the first posture data sent by the tracking device, where the first posture data is the posture data of the tracking device at the current moment obtained by the tracking device by performing integration processing according to the IMU data obtained through measurement, and after the IMU data sent by the tracking device is lost, where the tracking device continuously performs integration processing according to the IMU data obtained through measurement; and determines the real-time posture data of the tracking device at the current moment according to the first posture data. In this manner, the tracking device performs posture integration on the IMU data, and uploads the posture data obtained through integration to the headset, so that according to the posture data uploaded by the tracking device, the headset may recover, after the IMU is lost, the posture data obtained by the headset through integration, to obtain the correct posture data of the tracking device at the current moment.

FIG. 4 is a flowchart of a method of posture determining for a tracking device according to at least one embodiment of this application. This embodiment is described from the perspective of the tracking device. As shown in FIG. 4, the method provided in this embodiment includes the following steps.

At S201, obtain IMU data through measurement by using an IMU, and send the IMU data to a headset.

The IMU collects the IMU data at a first frequency, and sends the IMU data to the headset at the first frequency.

In an optional manner, the headset sends a connection message at the first frequency. After receiving the connection message sent by the headset, the tracking device sends a response message for the connection message, the response message carrying the IMU data obtained through measurement to the headset.

If the tracking device does not receive the connection message within a fixed period, the tracking device discards IMU data collected at a current receiving moment, that is, the tracking device does not cache the IMU data. If receiving the connection message at a next receiving moment, the tracking device sends the response message for the connection message carrying IMU data collected at the next receiving moment to the headset.

When the first frequency is 200 Hz, the headset sends the connection message once every 5 milliseconds, and correspondingly, the tracking device sends the response message for the connection message once every 5 milliseconds.

In another optional manner, the tracking device actively sends the IMU data to the headset at the first frequency, and does not need to send the IMU data only after receiving the connection message sent by the headset.

At S202, perform integration processing on the IMU data to obtain posture data of the tracking device, where after the IMU data sent to the headset is lost, the tracking device continuously performs integration processing according to the IMU data obtained through measurement.

In this embodiment, both the headset and the tracking device may determine, based on the connection message and the response message for the connection message, whether the IMU data is lost. After determining that the IMU data is lost, the headset stops performing posture integration processing on the tracking device. After determining that the IMU data is lost, the tracking device continues to perform posture integration processing on the tracking device.

A six-axis IMU and a microcontroller unit (Microcontroller Unit, MCU for short) chip are disposed inside the tracking device. The MCU chip may locally perform 3Dof integration processing by using the IMU data.

Assuming that the posture data at the current moment is Qₜ, and posture data at a next moment is Qₜ₊₁, in an exemplary manner, a 3Dof integration algorithm of the tracking device includes the following steps a-e.

At step a, calculate a rotation angle from the current moment to a next moment according to an angular velocity at the current moment.

The angular velocity at the current moment is the IMU data of the tracking device at the current moment. The angular velocity at the current moment includes angular velocities on three coordinate axes.

The rotation angle is calculated by using Δθ=ω*dt, where Δθ represents the rotation angle, ω represents the angular velocity at the current moment, dt represents a time difference between the current moment and the next moment, and the angular velocities on the three coordinate axes are substituted into the formula, to obtain rotation angles: Δθₓ⁻, Δθ_{y}, and Δθ_{z}, of the three coordinate axes.

At step b, calculate the total rotation angle θ according to the rotation angles of the three coordinate axes.

$$θ = \sqrt{{Δθ}_{x}^{2} + {Δθ}_{y}^{2} + {Δθ}_{z}^{2}}$$

At step c, calculate rotation axes: nx, ny, and nz of the three coordinate axes according to the rotation angles of the three coordinate axes.

For example, the rotation axes of the three coordinate axes are calculated in the following manner:

$$nx = {Δθ}_{x} / θ$$

$$ny = {Δθ}_{y} / θ$$

$$nz = {Δθ}_{z} / θ$$

At step d, calculate a posture quaternion variant dq according to the total rotation angle θ and the rotation axes nx, ny, and nz of the three coordinate axes.

For example, the posture quaternion variant dq is calculated by using the following formula:

$$dq = [ cos ( θ / 2 ) , sin ( θ / 2 ) * nx , sin ( θ / 2 ) * ny , sin ( θ / 2 ) * nz ]$$

At step e, calculate the posture data Qₜ₊₁ at the next moment according to the posture data Qₜ, at the current moment and the posture quaternion variant dq.

Where Qₜ₊₁=Qₜ*dq.

Optionally, the headset may also perform integration processing by using an integration algorithm in the foregoing manner. Certainly, the headset may also use an integration algorithm different from that of the tracking device. For example, the headset may use a more complex integration algorithm.

At S203, determine to send, at a current moment, first posture data that is obtained by the tracking device through integration, and send the first posture data to the headset.

The tracking device uses different integration processing operations for the foregoing two compensation manners.

In a first compensation manner, the first posture data is posture transformation information of the tracking device, obtained by the tracking device by performing integration processing on lost IMU data from a loss moment to the current moment.

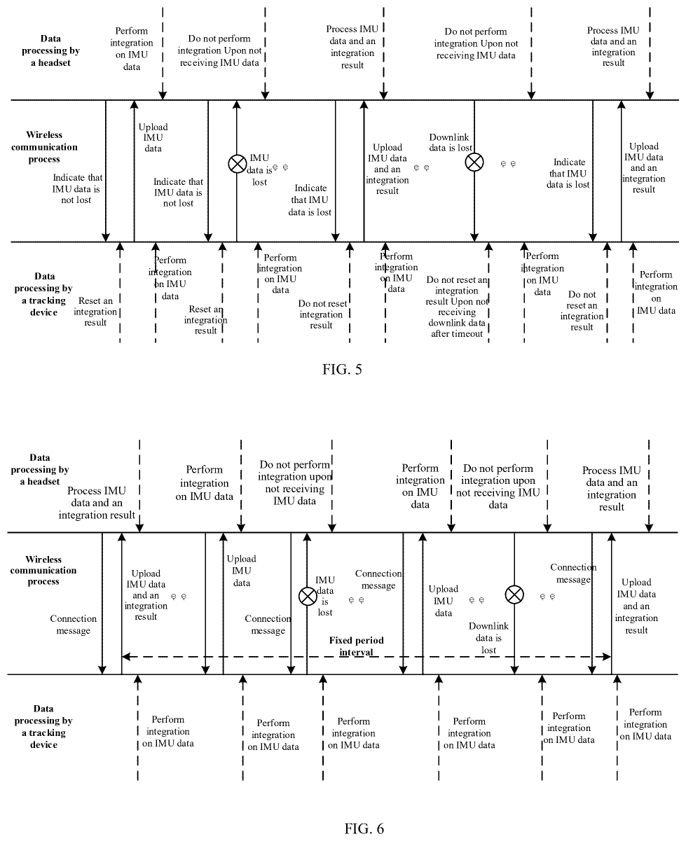

FIG. 5 is a sequence diagram of data transmission between the headset and the tracking device in the first compensation manner. With reference to FIG. 5, performing, by the tracking device, integration processing on the IMU data to obtain the posture data of the tracking device is specifically: receiving the connection message sent by the headset at the first frequency. When the connection message is received within a fixed period and the connection message indicates that the IMU data is not lost during sending, the posture data of the tracking device is reset, integration processing is continued according to the IMU data obtained through measurement, the response message for the connection message carrying the IMU data at the current moment is sent to the headset; and when the connection message is not received within the fixed period, it is determined that the IMU data is lost, the posture data of the tracking device is not reset, and integration processing is continued according to the IMU data obtained through measurement.

Correspondingly, determining to send, at the current moment, the first posture data that is obtained by the tracking device through integration includes: when the connection message is received for the first time after the IMU data is lost and when the connection message indicates that the IMU data is lost, determining to send, at the current moment, the first posture data that is obtained by the tracking device through integration, and in this case, skipping resetting the posture data of the tracking device, and sending the response message for the connection message to the headset, where the response message for the connection message includes the IMU data at the current moment and the first posture data that is obtained through integration. When the connection message is received for the first time after the IMU data is lost and the connection message indicates that the IMU data is lost, it indicates that normal transmission of the IMU data is recovered.

With reference to FIG. 5, the headset sends the connection message at the first frequency. When the IMU data is not lost, the connection message sent by the headset to the tracking device each time indicates that the IMU data is not lost. Correspondingly, integration processing performed by the tracking device on the IMU data includes: if the connection message indicates that the IMU data is not lost during sending, resetting the posture data of the tracking device (that is, resetting an integration result), and sending the response message for the connection message, with the response message carrying the IMU data, to the headset. Resetting the posture data of the tracking device means setting the posture data of the tracking device to 0 and restarting integration from initial posture data 0. The posture data of the tracking device obtained through such integration processing is a posture integration result of the IMU data.

IMU data loss includes IMU data loss caused by uplink data loss and IMU data loss caused by downlink data loss. For the IMU data loss caused by the uplink data loss, if the headset does not receive the response message for the connection message within the fixed period after sending the connection message, it is determined that the IMU data is lost. After determining that the IMU data is lost, the headset does not perform integration processing, and continuously sends the connection message at the first frequency, where the connection message indicates that the IMU data is lost. Before normal communication between the headset and the tracking device is recovered, the tracking device cannot receive the connection message, and therefore does not reset the posture data obtained through integration. When normal communication between the headset and the tracking device is recovered, the tracking device receives the connection message, and the connection message indicates that the IMU data is lost. According to the connection message, the tracking device does not reset the posture data, and sends the IMU data and an integration data (that is, the first posture data) to the headset. After receiving the IMU data and the integration result, the headset determines that normal communication of the IMU data is recovered, and determines, according to the integration result data, the real-time posture data of the tracking device at the current moment, and performs integration according to the IMU data.

For the IMU data loss caused by the downlink data loss, when the tracking device does not receive the connection message within the fixed period, it is determined that the IMU data is lost, the posture data of the tracking device is not reset, integration processing is continued, and other processing is the same as that for the IMU data loss caused by the uplink data loss, which is not repeated herein.

In a second compensation manner, the first posture data is the real-time posture data of the tracking device obtained by the tracking device by performing integration processing on all the IMU data from the initial moment to the current moment.

Correspondingly, performing, by the tracking device, the integration processing on the IMU data to obtain the posture data of the tracking device is specifically: performing, from the initial moment, integration on all the IMU data obtained through measurement, to obtain the real-time posture data of the tracking device. The initial moment may be a moment at which an XR application starts to run, and in a running process of the XR application, the method in the embodiment of present application is used to perform compensation on the posture of the tracking device.

Different from the first compensation manner, in this compensation manner, integration processing performed by the tracking device on the IMU data is not related to loss of the IMU data, and regardless of whether the IMU data is lost, the tracking device uses the same integration processing operation.

In this compensation manner, the tracking device may determine, according to a preset period, to send the first posture data at the current moment. For example, when the preset period is 1 second, and when an interval between two successive times at which the first posture data is sent reaches 1 second, it is determined to send the first posture data.

In this compensation manner, the tracking device does not need to determine, according to the connection message, whether the IMU data is lost and whether normal transmission is recovered. Therefore, the connection message sent by the tracking device may not carry an indication message for indicating whether the IMU data is lost, and may also certainly carry, in the connection message, the indication message for indicating whether the IMU data is lost, and the tracking device may carry the IMU data in the response message of each connection message. Alternatively, the headset does not need to send the connection message to the tracking device, and the tracking device actively sends the IMU data to the headset at the first frequency, and sends the first posture data to the headset at a preset period.

Optionally, the tracking device may also determine, in the following manner, to send, at the current moment, the first posture data obtained by the tracking device through integration: when receiving a request message sent by the headset, determining to send the first posture data at the current moment, where the request message is sent when the headset determines that the IMU data is lost and normal transmission is recovered, and the request message is used to request the tracking device to send the real-time posture data of the tracking device. The tracking device may send the response message for the request message carrying the first posture data to the headset. In this manner, the tracking device sends the first posture data only when the IMU data is lost. In comparison with periodically sending the first posture data, a quantity of sending times may be reduced.

Optionally, the tracking device may also determine, in the following manner, to send, at the current moment, the first posture data obtained by the tracking device through integration: when receiving the request message sent by the headset, and the request message indicates that the IMU data is lost, determining to send the first posture data at the current moment.

FIG. 6 is a sequence diagram of data transmission between the headset and the tracking device in the second compensation manner. By comparing FIG. 5 with FIG. 6, in the two compensation manners, the headset performs integration processing on the IMU data and sends the connection message in a same manner. Details are not described herein. On the side of the tracking device, in the second compensation manner, the tracking device performs integration processing on all the IMU data to obtain the real-time posture data of the tracking device, and periodically sends, to the headset according to a fixed period interval, the real-time posture data (that is, the integration result) obtained through integration.

The headset receives the real-time posture data obtained by the tracking device through integration, performs, according to the posture difference between the headset and the tracking device, posture adjustment on the real-time posture data obtained by the tracking device through integration, to obtain the real-time posture data of the tracking device at the current moment, where the real-time posture data of the tracking device at the current moment may be considered as the real-time posture data obtained by the headset by performing integration processing.

For the first compensation manner, optionally, in an implementation, when the tracking device receives the connection message and the connection message indicates that the IMU data is not lost, the tracking device does not perform integration processing. In other words, during normal communication, the tracking device does not perform integration processing, starts integration processing only when the IMU data is lost, and resets the integration result when normal transmission of the IMU data is recovered.

For the second compensation manner, when the headset does not send the connection message to the tracking device, the tracking device actively sends the IMU data to the headset at the first frequency, and actively sends, to the headset at a second frequency, the real-time posture data obtained by the tracking device by performing integration processing, where the second frequency is less than the first frequency. The headset may determine, based on the first frequency used by the tracking device to send the IMU data, whether the data is lost. By using an example in which the first frequency is 200 Hz, in a normal case, the headset receives one piece of IMU data at an interval of 5 milliseconds. If the IMU data is lost, the headset does not receive the IMU data for a long time. When receiving the IMU data again, the headset determines that normal transmission of the IMU data is recovered.

In this embodiment, the tracking device obtains the IMU data through measurement by using the IMU, sends the IMU data to the headset, and performs integration processing on the IMU data to obtain the posture data of the tracking device, where after the IMU data sent to the headset is lost, the tracking device continuously performs integration processing according to the IMU data obtained through measurement; and determines to send, at the current moment, the first posture data obtained by the tracking device through integration, and sends the first posture data to the headset. In this way, after the IMU data is lost and normal transmission is recovered, the headset may obtain the accurate posture of the tracking device.

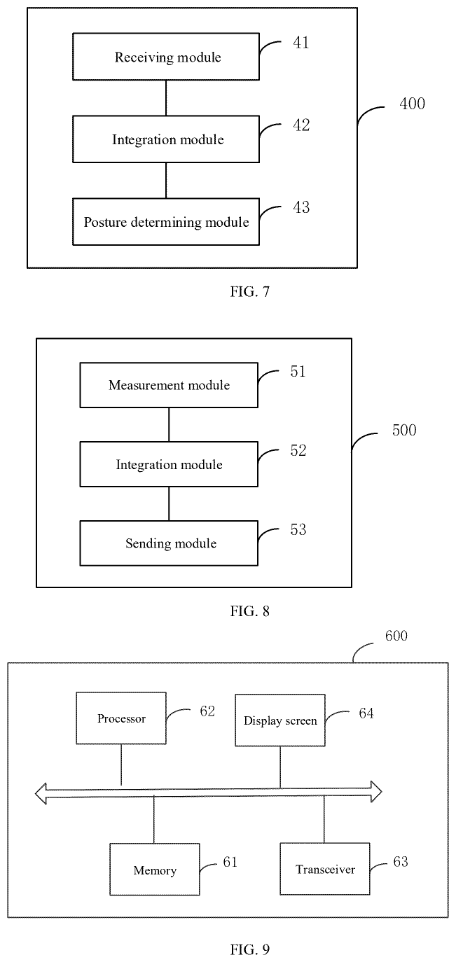

FIG. 7 shows an apparatus of posture determining for a tracking device according to at least one embodiment of this application. The apparatus of posture determining 400 for the tracking device is used in a headset. As shown in FIG. 7, the apparatus of posture determining 400 for the tracking device may include a receiving module 41, an integration module 42 and a posture determining module 43.

The receiving module 41 is configured to receive inertial measurement unit IMU data sent by the tracking device, where the IMU data is data obtained through measurement by an IMU of the tracking device.

The integration module 42 is configured to perform integration processing on the IMU data, to obtain real-time posture data of the tracking device;

The receiving module 41 is further configured to receive first posture data sent by the tracking device, where the first posture data corresponds to posture data of the tracking device at a current moment obtained by the tracking device by performing integration processing according to the IMU data obtained through measurement, and after the IMU data sent by the tracking device is lost, the tracking device continuously performs integration processing according to the IMU data obtained through measurement; and

The posture determining module 43 is configured to determine real-time posture data of the tracking device at the current moment according to the first posture data.

In an implementation, the first posture data is posture transformation information of the tracking device obtained by the tracking device by performing integration processing on lost IMU data from a loss moment of the IMU data to the current moment; and the posture determining module 43 is specifically configured to superpose the first posture data based on second posture data to obtain the posture data of the tracking device at the current moment, where the second posture data is real-time posture data of the tracking device at a first moment obtained by the headset through integration, and the first moment is a moment previous to the loss moment.

In an implementation, the first posture data is real-time posture data of the tracking device obtained by the tracking device by performing integration processing on all IMU data from an initial moment to the current moment; and the posture determining module 43 is specifically configured to: obtain a posture difference between the headset and the tracking device, where the posture difference indicates a difference between postures respectively obtained by the headset and the tracking device based on IMU data through integration; and perform posture adjustment on the first posture data according to the posture difference, to obtain the real-time posture data of the tracking device at the current moment.

In an implementation, the first posture data is periodically sent by the tracking device according to a preset period, and before the determining real-time posture data of the tracking device at the current moment according to the first posture data, the method further includes: determining, by the headset, whether the IMU data is lost and whether normal transmission is recovered at the current moment; when it is determined that the IMU data is not lost, updating the posture difference according to the first posture data and the real-time posture data that is obtained by the headset at the current moment by performing integration processing based on the IMU data; and when it is determined that the IMU data is lost and normal transmission is recovered at the current moment, determining to determine the real-time posture data of the tracking device at the current moment by using the first posture data.

In an implementation, the posture determining module 43 is further configured to: determine whether the IMU data sent by the tracking device is lost; and when the IMU data sent by the tracking device is lost, determine to determine the real-time posture data of the tracking device at the current moment by using the first posture data.

In an implementation, the apparatus 400 further includes a repositioning module, configured to: collect light spot images of a plurality of light emitting units on the tracking device; and reposition the tracking device by using a pose estimation algorithm according to the light spot images. The integration module 42 is specifically configured to perform integration processing on the IMU data by using a repositioned posture as an initial posture, to obtain the real-time posture data of the tracking device.

In an implementation, the headset performs integration processing by using a first integration algorithm, the tracking device performs integration processing by using a second integration algorithm, and the first integration algorithm is different from the second integration algorithm.

In an implementation, the apparatus 400 further includes a sending module. The sending module is configured to send a connection message to the tracking device at a first frequency. When the IMU data is not lost, the connection message carries indication information indicating that the IMU data is not lost, and the tracking device sends the IMU data by using a response message for the connection message.

If the response message for the connection message sent by the tracking device is not received within a fixed period after the sending module sends the connection message, it determines that the IMU data is lost, where after the IMU data is lost, the connection message carries the indication information indicating that the IMU data is lost.

The apparatus in this embodiment may be configured to perform the method steps performed by the headset in the foregoing method embodiment. For a specific implementation, reference is made to related descriptions of the method embodiment, and details are not described herein.

FIG. 8 shows an apparatus of posture determining for a tracking device according to Embodiment 4 of this application. The apparatus of posture determining 500 for the tracking device is used in the tracking device. As shown in FIG. 8, the apparatus of posture determining 500 for the tracking device may include a measurement unit 51, an integration module 52 and a sending module 53.

The measurement unit 51 is configured to obtain IMU data through measurement by using an inertial measurement unit IMU, and send the IMU data to a headset;

The integration module 52 is configured to perform integration processing on the IMU data to obtain posture data of the tracking device, where after the IMU data sent to the headset is lost, the tracking device continuously performs integration processing according to the IMU data obtained through measurement; and

The sending module 53 is configured to determine to send, at a current moment, first posture data obtained by the tracking device through integration, and send the first posture data to the headset.

In an implementation, the first posture data is posture transformation information of the tracking device obtained by the tracking device by performing integration processing on lost IMU data from a loss moment of the IMU data to the current moment.

When the first posture data is posture transformation information of the tracking device obtained by the tracking device by performing integration processing on lost IMU data from a loss moment of the IMU data to the current moment, in an implementation, the integration module 52 is specifically configured to: receive a connection message sent by the headset at a first frequency; when the connection message is received within a fixed period and the connection message indicates that the IMU data is not lost during sending, reset the posture data of the tracking device, and continue to perform integration processing according to the IMU data obtained through measurement, where the tracking device sends the IMU data by using a response message for the connection message; and when the connection message is not received within the fixed period, determine that the IMU data is lost, skip resetting the posture data of the tracking device, and continue to perform integration processing according to the IMU data obtained through measurement.

When the first posture data is posture transformation information of the tracking device obtained by the tracking device by performing integration processing on lost IMU data from a loss moment of the IMU data to the current moment, in an implementation, the sending module 53 is specifically configured to: when the connection message is received for the first time after the IMU data is lost and when the connection message indicates that the IMU data is lost, determine to send, at the current moment, the first posture data that is obtained by the tracking device through integration, skip resetting the posture data of the tracking device, and send the response message for the connection message to the headset, where the response message for the connection message includes IMU data at the current moment and the first posture data.

In an implementation, the first posture data is real-time posture data of the tracking device and obtained by the tracking device by performing integration processing on all IMU data from an initial moment to the current moment; and the integration module 52 is specifically configured to perform, from the initial moment, integration on all the IMU data obtained through measurement, to obtain the real-time posture data of the tracking device.

When the first posture data is real-time posture data of the tracking device obtained by the tracking device by performing integration processing on all IMU data from an initial moment to the current moment, in an implementation, the sending module 53 is specifically configured to: determine, according to a preset period, to send the first posture data at the current moment.

When the first posture data is real-time posture data of the tracking device obtained by the tracking device by performing integration processing on all IMU data from an initial moment to the current moment, in an implementation, the sending module 53 is specifically configured to: when receiving a request message sent by the headset, determine to send the first posture data at the current moment, where the request message is sent when the headset determines that the IMU data is lost and normal transmission is recovered, and the request message is used to request the tracking device to send its own real-time posture data.

In an implementation, the sending module 53 is specifically configured to: receive a connection message sent by the headset according to a first frequency; and send a response message for the connection message to the headset, where the response message for the connection message includes the first posture data and IMU data at the current moment.

The apparatus in this embodiment may be configured to perform the method steps performed by the tracking device in the foregoing method embodiment. For a specific implementation, reference is made to related descriptions of the method embodiment, and details are not described herein.

It should be understood that the apparatus embodiment may correspond to the method embodiment, and for similar descriptions, reference may be made to the method embodiment. To avoid repetition, details are not described herein.

The foregoing describes the apparatuses 400 and 500 in embodiments of this application from the perspective of the functional modules. It should be understood that, the functional module may be implemented in a hardware form, may be implemented through instructions in a software form, or may be implemented through a combination of hardware and software modules. Specifically, steps of the method embodiments in embodiments of this application may be completed through an integrated logic circuit and/or instructions in a software form in a processor. Steps of the methods disclosed with reference to embodiments of this application may be directly performed by a hardware decoding processor, or may be performed by using a combination of hardware and software modules in the decoding processor. Optionally, the software module may be located in a mature storage medium in the art, such as a random access memory, a flash memory, a read-only memory, a programmable read-only memory, an electrically erasable programmable memory, a register or the like. The storage medium is located in the memory, and the processor reads information in the memory and completes the steps in the foregoing method embodiments in combination with hardware of the processor.

An embodiment of this application further provides a headset. FIG. 9 is a schematic structural diagram of a headset according to Embodiment 5 of this application. As shown in FIG. 9, the headset 600 may include a memory 61 and a processor 62.

The memory 61 is configured to: store a computer program, and transmit the program code to the processor 62. In other words, the processor 62 may call the computer program from the memory 61 and run the computer program, to implement the method steps performed by the headset in embodiments of this application.

For example, the processor 62 may be configured to perform, according to instructions in the computer program, the method steps performed by the headset in the foregoing method embodiments.

In some embodiments of this application, the processor 62 may include but is not limited to: a general-purpose processor, a digital signal processor (Digital Signal Processor, DSP), an application specific integrated circuit (Application Specific Integrated Circuit, ASIC), a field programmable gate array (Field Programmable Gate Array, FPGA) or another programmable logic device, a discrete gate or a transistor logic device, a discrete hardware component, or the like.

In some embodiments of this application, the memory 61 includes but is not limited to: a volatile memory and/or a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), used as an external cache. Through example but not limitative descriptions, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), and a direct rambus random access memory (direct rambus RAM, DR RAM).

In some embodiments of this application, the computer program may be divided into one or more modules. The one or more modules are stored in the memory 61, and are executed by the processor 62, to complete the method provided in this application. The one or more modules may be a series of computer program instruction segments that may complete specific functions, where the instruction segments are used to describe an execution process of the computer program in a server.

As shown in FIG. 9, the headset 600 may further include: a transceiver 63, a display screen 64, and the like. The processor 62 is separately electrically connected to the transceiver 63 and the display screen 64.

The processor 62 may control the transceiver 63 to communicate with another device, specifically, to send information or data to another device, or receive information or data sent by another device. The transceiver 63 may include a transmitter and a receiver. The transceiver 63 may further include an antenna, and there may be one or more antennas.

The display screen 64 may be configured to display various virtual reality scenes, a VST video, and the like. The display screen 64 may use one or two organic light-emitting diode (OLED) displays, and may certainly also use a solution of a display of another type, for example, two small displays, a micro display, or a flexible display.

It may be understood that, although not shown in FIG. 9, the headset 600 may further include a camera module, a wireless fidelity WIFI module, a Bluetooth module, a power module, and the like, and details are not described herein.

It should be understood that, the components in the headset 600 are connected through a bus system. In addition to a data bus, the bus system further includes a power bus, a control bus, and a status signal bus.

An embodiment of this application further provides a tracking device. The tracking device includes a processor, a memory, a transceiver, and an IMU. The processor is communicatively connected to the memory, the transceiver, and the IMU. The memory is configured to store a computer program. The transceiver is configured to communicate with a headset. The IMU is configured to measure IMU data. The processor is configured to call and run the computer program stored in the memory, to perform the method steps performed by the tracking device in the foregoing method embodiment. Optionally, the tracking device further includes a plurality of light emitting units, configured to assist the headset in repositioning the tracking device.

This application further provides a computer storage medium, on which a computer program is stored, which, when executed by a processor, enable the computer to perform the method steps performed by the headset or the method steps performed by the tracking device in the foregoing method embodiments. For brevity, details are not described herein.

This application further provides a computer program product, where the computer program product includes a computer program, and the computer program is stored in a computer-readable storage medium. A processor of a headset reads the computer program from the computer-readable storage medium. The processor executes the computer program, so that the headset performs the method steps performed by the headset in the foregoing method embodiment. For brevity, details are not described herein.

This application further provides a computer program product, where the computer program product includes a computer program, and the computer program is stored in a computer-readable storage medium. A processor of a tracking device reads the computer program from the computer-readable storage medium. The processor executes the computer program, so that the tracking device performs the method steps performed by the tracking device in the foregoing method embodiment. For brevity, details are not described herein.

In several embodiments provided in this application, it should be understood that the disclosed system, apparatus, and method may be implemented in another manner. For example, the apparatus embodiments described above are merely examples. For example, division of the modules is merely logic function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electronic, mechanical, or other forms.

The modules described as separate parts may or may not be physically separate, and parts displayed as modules may or may not be physical modules, that is, may be located in one position, or may be distributed on a plurality of network units. Some or all of the modules may be selected based on actual requirements, to achieve the objective of the solution of this embodiment. For example, functional modules in embodiments of this application may be integrated into one processing module, each of the modules may exist physically alone, or two or more modules may be integrated into one module.

The above is only the specific implementation of this application, but the protection scope of this application is not limited thereto. Any skilled in the art may easily think of changes or substitutions within the technical scope disclosed in this application, which should be included in the protection scope of this application. Therefore, the protection scope of this application should be based on the protection scope of this claim.

1. A method of posture determining for a tracking device, the method being applicable to a headset and comprising:
receiving inertial measurement unit (IMU) data sent by the tracking device, wherein the IMU data is data obtained through measurement by an IMU of the tracking device;
performing integration processing on the IMU data, to obtain real-time posture data of the tracking device;
receiving first posture data sent by the tracking device, wherein the first posture data is posture data of the tracking device at a current moment, obtained by the tracking device by performing integration processing according to the IMU data obtained through measurement, and after the IMU data sent by the tracking device is lost, the tracking device continuously performs integration processing according to the IMU data obtained through measurement; and
determining real-time posture data of the tracking device at the current moment according to the first posture data.

2. The method according to claim 1, wherein the first posture data is posture transformation information of the tracking device, obtained by the tracking device by performing integration processing on lost IMU data from a loss moment of the IMU data to the current moment; and
the determining the real-time posture data of the tracking device at the current moment according to the first posture data comprises:
superposing the first posture data based on second posture data to obtain the posture data of the tracking device at the current moment, wherein the second posture data is real-time posture data of the tracking device at a first moment, obtained by the headset through integration, and the first moment is a moment previous to the loss moment.

3. The method according to claim 1, wherein the first posture data is real-time posture data of the tracking device, obtained by the tracking device by performing integration processing on all IMU data from an initial moment to the current moment; and
the determining the real-time posture data of the tracking device at the current moment according to the first posture data comprises:
obtaining a posture difference between the headset and the tracking device, wherein the posture difference indicates a difference between postures respectively obtained by the headset and the tracking device based on the IMU data through integration; and
performing posture adjustment on the first posture data according to the posture difference, to obtain the real-time posture data of the tracking device at the current moment.

4. The method according to claim 3, wherein the first posture data is periodically sent by the tracking device according to a preset period, and before the determining the real-time posture data of the tracking device at the current moment according to the first posture data, the method further comprises:
determining, by the headset, whether the IMU data is lost and whether normal transmission is recovered at the current moment;
in response to that it is determined that the IMU data is not lost, updating the posture difference according to the first posture data and the real-time posture data, wherein the real-time posture data is obtained by the headset at the current moment by performing integration processing based on the IMU data; and
in response to that it is determined that the IMU data is lost and normal transmission is recovered at the current moment, determining to determine the real-time posture data of the tracking device at the current moment by using the first posture data.

5. The method according to claim 1, further comprising:
collecting light spot images of a plurality of light emitting units on the tracking device; and
repositioning the tracking device by using a pose estimation algorithm according to the light spot images; and
the performing integration processing on the IMU data, to obtain the real-time posture data of the tracking device comprises:
performing integration processing on the IMU data by using a repositioned posture as an initial posture, to obtain the real-time posture data of the tracking device.

6. The method according to claim 1, wherein the headset performs integration processing by using a first integration algorithm, the tracking device performs integration processing by using a second integration algorithm, and the first integration algorithm is different from the second integration algorithm.

7. The method according to claim 1, further comprising:
sending a connection message to the tracking device according to a first frequency, wherein in response to that the IMU data is not lost, the connection message carries indication information indicating that the IMU data is not lost, and the tracking device sends the IMU data through a response message for the connection message; and
in response to that the response message for the connection message sent by the tracking device is not received within a fixed period after sending the connection message, determining that the IMU data is lost, and after determining that the IMU data is lost, the connection message carries the indication information indicating that the IMU data is lost.

8. A method of posture determining for a tracking device, the method being applicable to the tracking device and comprising:
obtaining inertial measurement unit (IMU) data through measurement by an IMU, and sending the IMU data to a headset;
performing integration processing on the IMU data to obtain posture data of the tracking device, wherein after the IMU data sent to the headset is lost, the tracking device continuously performs integration processing according to the IMU data obtained through measurement; and
determining to send, at a current moment, first posture data that is obtained by the tracking device through integration, and sending the first posture data to the headset.

9. The method according to claim 8, wherein the first posture data is posture transformation information of the tracking device, obtained by the tracking device by performing integration processing on lost IMU data from a loss moment of the IMU data to the current moment.

10. The method according to claim 9, wherein the performing integration processing on the IMU data to obtain the posture data of the tracking device comprises:
receiving a connection message sent by the headset according to a first frequency;
in response to that the connection message is received within a fixed period and the connection message indicates that the IMU data is not lost during sending, resetting the posture data of the tracking device, and continuing to perform integration processing according to the IMU data obtained through measurement, wherein the tracking device sends the IMU data through a response message for the connection message; and
in response to that the connection message is not received within the fixed period, determining that the IMU data is lost, skipping resetting the posture data of the tracking device, and continuing to perform integration processing according to the IMU data obtained through measurement.

11. The method according to claim 10, wherein the determining to send, at the current moment, the first posture data that is obtained by the tracking device through integration comprises:
in response to that the connection message is received for the first time after the IMU data is lost and the connection message indicates that the IMU data is lost, determining to send, at the current moment, the first posture data that is obtained by the tracking device through integration, skipping resetting the posture data of the tracking device, and sending the response message for the connection message to the headset, wherein the response message for the connection message comprises IMU data at the current moment and the first posture data.

12. The method according to claim 8, wherein the first posture data is real-time posture data of the tracking device, obtained by the tracking device by performing integration processing on all IMU data from an initial moment to the current moment; and
the performing integration processing on the IMU data to obtain the posture data of the tracking device comprises:
performing, from the initial moment, integration on all the IMU data obtained through measurement, to obtain the real-time posture data of the tracking device.

13. The method according to claim 12, wherein the determining to send, at the current moment, the first posture data that is obtained by the tracking device through integration comprises:
determining, according to a preset period, to send the first posture data at the current moment.

14. The method according to claim 12, wherein the determining to send, at the current moment, the first posture data that is obtained by the tracking device through integration comprises:
upon receiving a request message sent by the headset, determining to send the first posture data at the current moment, wherein the request message is sent in response to that the headset determines that the IMU data is lost and normal transmission is recovered, and the request message is used to request the tracking device to send the real-time posture data of the tracking device.

15. The method according to claim 13, wherein the sending the first posture data to the headset comprises:
receiving a connection message sent by the headset according to a first frequency; and
sending a response message for the connection message to the headset, wherein the response message for the connection message comprises the first posture data and IMU data at the current moment.

16. A headset, comprising:
at least a processor and a memory, wherein the memory is configured to store a computer program, and the processor is configured to call and run the computer program stored in the memory, to perform a method of posture determining for a tracking device, and
the method comprises:
receiving inertial measurement unit (IMU) data sent by the tracking device, wherein the IMU data is data obtained through measurement by an IMU of the tracking device;
performing integration processing on the IMU data, to obtain real-time posture data of the tracking device;
receiving first posture data sent by the tracking device, wherein the first posture data is posture data of the tracking device at the current moment and is obtained by the tracking device by performing integration processing according to the IMU data obtained through measurement, and after the IMU data sent by the tracking device is lost, the tracking device continuously performs integration processing according to the IMU data obtained through measurement; and
determining real-time posture data of the tracking device at the current moment according to the first posture data.

17. A tracking device, comprising:
at least a processor and a memory, wherein the memory is configured to store a computer program, and the processor is configured to call and run the computer program stored in the memory, to perform the method according to claim 8.

18. The headset according to claim 16, wherein the first posture data is posture transformation information of the tracking device, obtained by the tracking device by performing integration processing on lost IMU data from a loss moment of the IMU data to the current moment; and
the determining real-time posture data of the tracking device at the current moment according to the first posture data comprises:
superposing the first posture data based on second posture data to obtain the posture data of the tracking device at the current moment, wherein the second posture data is real-time posture data of the tracking device at a first moment obtained by the headset through integration, and the first moment is a moment previous to the loss moment.

19. The headset according to claim 16, wherein the first posture data is real-time posture data of the tracking device, obtained by the tracking device by performing integration processing on all IMU data from an initial moment to the current moment; and
the determining real-time posture data of the tracking device at the current moment according to the first posture data comprises:
obtaining a posture difference between the headset and the tracking device, wherein the posture difference indicates a difference between postures respectively obtained by the headset and the tracking device based on IMU data through integration; and
performing posture adjustment on the first posture data according to the posture difference, to obtain the real-time posture data of the tracking device at the current moment.

20. The method according to claim 14, wherein the sending the first posture data to the headset comprises:
receiving a connection message sent by the headset according to a first frequency; and
sending a response message for the connection message to the headset, wherein the response message for the connection message comprises the first posture data and IMU data at the current moment.
